(19) United States
(12) Patent Application Publication
(10) Pub. No.: US 2026/0166651 A1
(43) Pub. Date: Jun. 18, 2026

(54) DECORATION MACHINE FOR DECORATING CONTAINERS WITH LASER DECORATION UNITS PROVIDED WITH SWITCHING FUNCTIONALITY

(71) Applicant: SIDEL PARTICIPATIONS, OCTEVILLE-SURMER (FR)

(72) Inventors: Mattia GIULIANI, Mantova (IT); Antonio MANCINO, Mantova (IT)

(21) Appl. No.: 18/875,622

(22) PCT Filed: Jun. 15, 2023
(86) PCT No.: PCT/EP2023/066135

§ 371 Date: Dec. 16, 2024

(51) Int. Cl. B23K 26/08; B23K 26/082; B23K 26/362

(52) U.S. Cl. CPC B23K 26/0838; B23K 26/082; B23K 26/362

(57) ABSTRACT

Described is a decoration machine for decorating containers adapted to contain a pourable product. The machine includes for each group of container support members, a respective laser decoration unit for engraving a decoration on the containers supported by the support members. Each laser decoration unit includes: a respective laser source configured to emit a laser beam; at least two respective laser engraving devices, each configured to receive the laser beam and each associated with one respective support member for engraving a container supported thereon with the laser beam, where each device is integral with the advancement of the associated support member; and a respective switching device operatively interposed between the laser source and each laser engraving device of the unit, where the switching device selectively directs the laser beam towards each engraving device.

### TECHNICAL FIELD

The present invention relates to a decoration machine for decorating containers, such as bottles, jars, flacons or the like, adapted to contain a pourable product, preferably a pourable food product, with laser decoration.

### BACKGROUND ART

Decoration machines are known for decorating containers adapted to contain a pourable product.

A common widespread type of decoration machine are labelling machines.

In particular, labelling machines are known, which are commonly used to prepare, transport and apply labels onto containers such as bottles, flacons, jars or the like, destined to be filled with a pourable product, in particular a pourable food product.

Labelling machines of this sort typically operate with well-known “glued labels”, which are cut from a web of labelling material at appropriate lengths, sprinkled with glue and then applied on the containers.

In other embodiments, labelling machines can operate with so-called “sleeve-labels”, which are cut from a web of heat-shrinking film, are applied with a certain clearance on the articles, and then heated in an oven to obtain their shrinking and perfect adhesion to the lateral surfaces of the containers.

Regardless of the type of label used, a known labelling machine typically comprises:
a carousel rotatable around a vertical axis and configured to convey a plurality of containers along a horizontal, arc-shaped labelling path; and
a labelling module, peripherally arranged relatively to the carousel (i.e. radially with respect to the aforementioned vertical axis) and configured to prepare, transport and feed a plurality of labels to the carousel at an application station, in order to apply such labels to the respective containers.

The carousel comprises a series of support members, for example embodied as support plates, arranged at a peripheral portion thereof and each configured to support a respective container.

The carousel advances the support members along a circular trajectory, so that the containers are advanced along the labelling path.

Typically, the labelling module essentially comprises:
at least one support shaft around which the web of labelling material is initially wound in form of a reel;
a feed roller for unwinding the web off the reel and advance it along a feed path;
a cutting unit for repeatedly cut the web at a cutting station so as to separate a sequence of labels from the web itself; and
a transfer drum, for example a known vacuum drum arranged peripherally to the carousel, configured to receive, retain by suction and advance each label previously cut and to feed each label to the carousel, at the application station.

In case glued labels are used, the labelling module further comprises a gluing roller arranged peripherally to the transfer drum, for sequentially sprinkling with glue each label retained and transferred by the drum itself.

From the above, it is clear that the known decoration machines comprise a lot of different units and devices and entail the use of several raw materials, which render the decoration process rather cumbersome and complicated, and also difficult to adapt to a container format change. Hence, the known decoration machines entail a large number of components, which require maintenance and which lower the overall reliability of the decoration machine.

### DISCLOSURE OF INVENTION

It is therefore an object of the present invention to provide a decoration machine which is designed to overcome at least one of the above-mentioned drawbacks in a straightforward and low-cost manner.

This object is achieved by a decoration machine as claimed in claim 1.

### BRIEF DESCRIPTION OF THE DRAWINGS

A non-limiting embodiment of the present invention will be described by way of example with reference to the accompanying drawings, in which:

FIG. 1 is a schematic top view, with parts removed for clarity, of a decoration machine according to the present invention;

FIG. 2 is a larger-scale, schematic lateral view, with parts removed for clarity, of the decoration machine of FIG. 1 in a first instant during the use of the machine; and

FIG. 3 is a larger-scale, schematic lateral view, with parts removed for clarity, of the decoration machine of FIG. 1 in a second instant during the use of the machine.

### BEST MODE FOR CARRYING OUT THE INVENTION

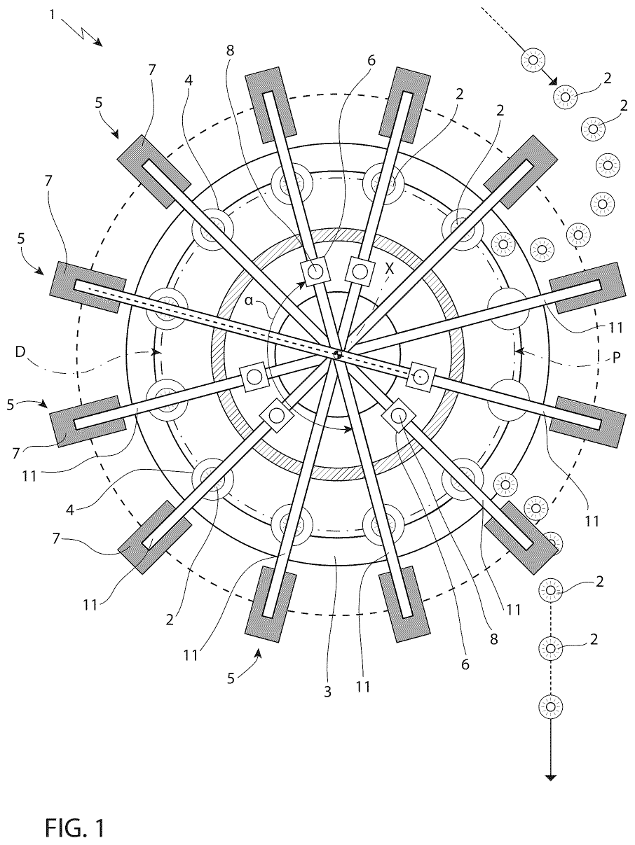

With reference to FIG. 1, number 1 indicates as a whole a decoration machine for decorating containers 2, such as bottles, jars, flacons or the like, adapted to contain a pourable product, preferably a pourable food product (water, beer, wine, milk, juice, yogurt, or the like).

Containers 2 are preferably made of plastic material, such as PET, or of glass. Containers may be cans, plastic bottles or glass bottles.

Preferably, decoration machine 1 is part of a packaging assembly (not shown) of the known type which is configured for packaging the pourable product by means of the containers 2.

To this end, the packaging assembly may comprise:
a filling machine (not shown) for filling containers 2 with the pourable product;
a capping machine (not shown) for capping the filled containers; and
the decoration machine 1.

The filling machine, the capping machine and the decoration machine are preferably synchronized with one another.

The machine 1 comprises a rotary conveyor 3 for conveying a plurality of containers 2 along a decoration path D. The rotary conveyor 3 is configured to convey the containers 2 along the decoration path D by means of a rotary movement.

The machine 1 comprises a plurality of support members 4 mounted on the conveyor 3 for being advanced along the decoration path D. Each support member 4 is configured to support in advancement a respective container 2. Each support member 4 is integral with said rotary movement.

The rotary conveyor comprises a carousel 3 rotatable about a central axis X, so that the decoration path D is arc-shaped and so that said rotary movement comprises a rotation about the central axis X. The support members 4 are mounted on a radial peripheral portion of the carousel 3, with respect to the central axis X, so as to be advanced by the carousel 3 along a circular path P including the decoration path D.

The plurality of support members 4 includes at least one group of support members 4. The plurality of support members 4 may comprise a plurality of groups of support members 4. Each group comprises at least two respective support members 4. At least two support members 4 of each group 4 are located at diametrically opposite locations with respect to axis X. It may be, in another not shown embodiment, that at least three support members 4 of each group are located at 120° from each other.

The machine 1 comprises, for each group of support members 4, a respective laser decoration unit 5 for engraving a decoration on the containers 2 supported by the support members 4 of the group.

Each decoration unit 5 comprises a respective laser source 6 configured to emit a laser beam L. Each unit 5 comprises at least two respective laser engraving devices 7, each configured to receive the laser beam L and each associated to one respective support member 4 of the group for engraving a container 2 supported thereon by means of the received laser beam L. Each laser device 7 is integral with the advancement of the associated support member 4, to improve the accuracy of the decoration. Each laser device 7 may comprise a lens.

At least two engraving device 7 of the unit 5 are located at diametrically opposite locations with respect to axis X. It may be, in another not shown embodiment, that at least three engraving device 7 of each unit 5 are located at 120° from each other.

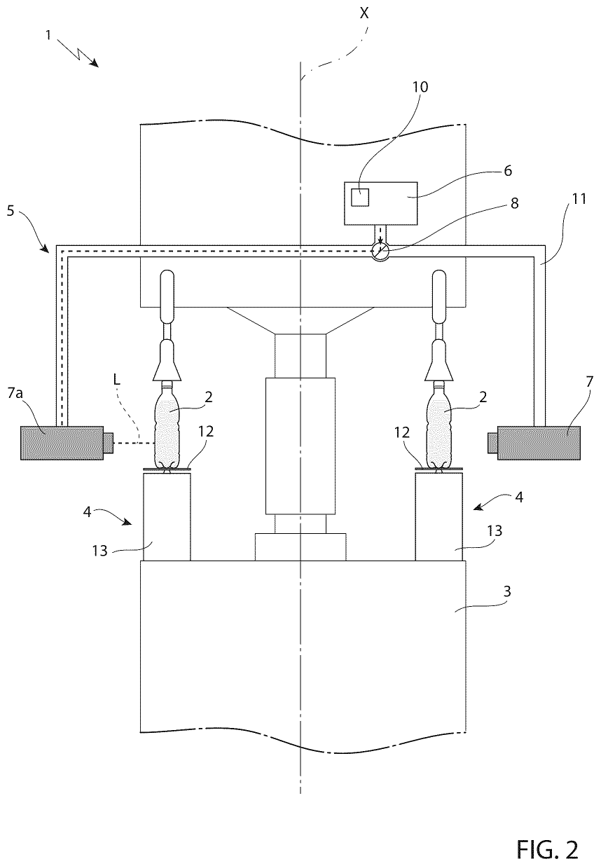

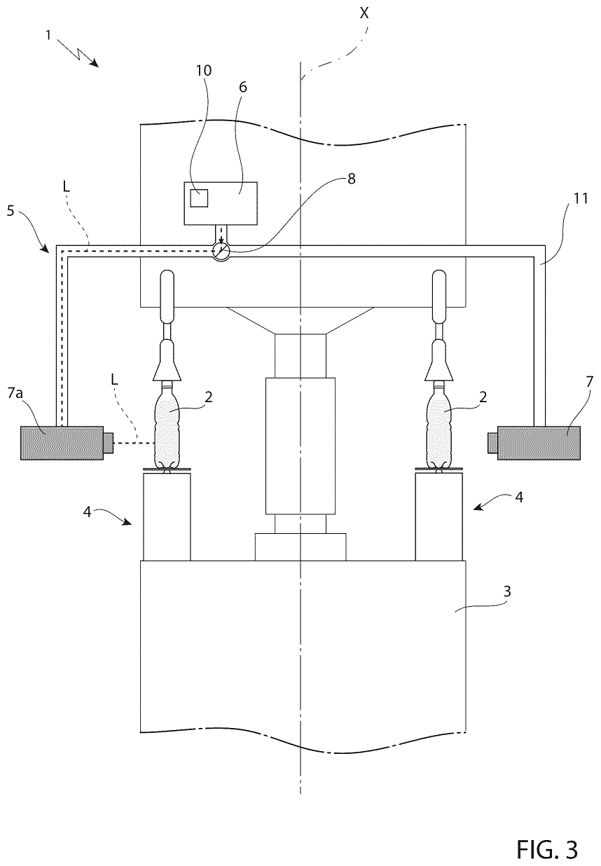

Each decoration unit 5 comprises a respective switching device 8 which is operatively interposed between the laser source 6 and each engraving device 7 of the unit 5. The switching device 8 is configured for selectively directing the laser beam L towards each engraving device 7 of the unit 5. FIGS. 2 and 3 are referred to the same decoration unit 5. In FIG. 2, the laser beam is directed towards the device 7a, and not towards the other laser device 7. In FIG. 3, the laser beam is directed towards the device 7a, and not towards the other device 7. The device 7a of FIG. 2 is different from the device 7a of FIG. 3.

The switching device 8 may therefore direct the laser towards more than one laser device 7 simultaneously.

In detail, each laser decoration unit 5 emits concentrated electromagnetic radiation (light) with a defined emission wavelength, thereby generating a sort of micro-burning on the outer surface of the container 2, engraving the decoration thereon.

This results in: an improved cleanliness of the decoration process, since no glue is used; a highly reduced consumption of raw materials (since no glue and no labelling material is needed) ; avoiding undesired mispositioning of the decorations (e.g. labels) due to glue misapplication or due to accidental removal or displacement of the labels after production (e.g. during transport).

The machine 1 comprises at least one control unit 10 for controlling the switching device 8 of each decoration unit 5. The at least one control unit 10 is configured, for each decoration unit 5, for automatically selecting each engraving device 7 of the decoration unit 5 depending on the position of the associated support member 4 along the decoration path D. The at least one control unit 10 is configured for automatically controlling the switching device 8 of each decoration unit 5 so that the laser beam L is directed towards each selected laser engraving device 7a of the decoration unit 5. More than one laser device 7 may be simultaneously selected. Therefore, for each decoration unit 5 the at least one control unit 10 may not select at least one laser device 7 of the decoration unit 5 and select at least another one laser device 7 of the decoration unit 5.

FIGS. 2 and 3 are referred to the same decoration unit 5. In both FIGS. 2 and 3, the selected device is indicated with 7a. The selected device 7a of FIG. 2 is different from the selected device 7a of FIG. 3.

In this way, at constant production speed, less laser sources can be used in the machine, to simplify mechanical architecture of the machine 1.

Hence, the total number of components of decoration machine 1 can be reduced. This results in a simplified architecture, reduced costs, simplified maintenance operations and in an increase in the overall reliability of decoration machine 1.

For each laser decoration unit 5, the switching device 8 comprises a respective optical switch for deviating the laser beam L towards each selected laser engraving device 7a.

The machine 1 comprises an aspirator device configured for sucking residual particles of the containers 2 following the engraving thereof by means of the laser engraving devices 7.

In this way, cleanliness of the decoration process is further improved.

Each laser engraving device 7 is arranged in a position radially more external than the position of the associated support member 4, with respect to said central axis X.

Opportunely, each laser engraving device 7 points radially inwards towards axis X, in order to engrave the respective container 2.

Thanks to this configuration, the overall safety of the decoration process by laser engraving is improved, since the laser engraving devices 7 are pointing inwards and not outwards, whereby the laser beam L could hit operators or other machines or units, damaging them.

Moreover, this configuration is particularly advantageous also in terms of space: assembling and maintenance of the laser engraving devices 7 are eased, since they are easily accessible even when the machine 1 is loaded with containers 2 and without the need for dismounting any part of the machine 1.

According to an alternative embodiment not shown, laser engraving devices 7 may be radially more internal with respect to support members 4 associated therewith.

This latter configuration has the advantage that the footprint of the decoration machine 1 is reduced, which feature is preferable in some cases rather than higher safety and accessibility.

Each laser decoration unit 5 comprises a respective supporting structure 11 which is mounted to the rotary conveyor 3. The supporting structure 11 is integral with said rotary movement and supports each laser engraving device 7 of the decoration unit 5 so that each laser engraving device 7 of the decoration unit 5 is integral with said rotary movement. In this way the decoration of each container 2 can be very accurate. For each decoration unit 5, the supporting structure 11 supports also the laser source 6 and the switching device 8, so that each of the laser source 6 and switching device 8 is integral with said rotary movement. The at least one control unit 10 may comprise a respective control unit 10 for each decoration unit 5, for controlling the respective switch 8. In this case, for each decoration unit 5, the supporting structure 11 supports also the control unit 10.

The optical switch may be defined by a system of mirrors arranged within structure 11.

For each laser decoration unit 5, the supporting structure 11 is configured to convey the laser beam L from the respective laser source 6 selectively to each laser engraving device 7 of the decoration unit 5, in such a way that the laser beam L is directed from the switching device 8 to each selected laser engraving device 7a through the supporting structure 11. This results in a further simplification of the mechanical architecture of the machine 1, as the supporting structure 11 is used both for conveying the beam and for making the engraving devices 7 integral with the rotary movement of the conveyor 3. Decoration machine 1 has a more compact design and a simplified architecture, since there is no need for dedicated transmission means for the laser beam L.

The machine 1 is configured so that each container is engraved along a decoration angular sector a, with respect to said axis X. For each laser decoration unit 5, the at least one control unit 10 is configured for selecting each laser engraving device 7 for which the associated support member 4 is within the decoration angular sector a. Therefore, the laser beam is directed towards each device 7 that is transiting along the decoration sector a. In this way, at constant production speed, less laser sources can be used in the machine, to simplify mechanical architecture of the machine 1.

In each of FIGS. 2 and 3, the laser device indicated with 7a is within the decoration sector, while the other one is not within the decoration sector. In each of FIGS. 2 and 3, the laser device indicated with 7a is therefore selected, while the other one is therefore not selected.

For each unit 5, each laser engraving device 7 is mounted on the supporting structure 11 so as to be movable, in the axial direction and/or in the radial direction, with respect to said central axis X, and relatively to the associated support member 4.

Conveniently, machine 1 comprises dedicated actuators and control units, of the known type, for determining the aforementioned movement of each device 7.

In this way, the decoration process can be easily adapted to specific needs or specific shapes of containers 2.

In fact, thanks to the above configuration:
a decoration can be engraved along the entire axial length of the containers 2; and
a precise control of the distance between the laser engraving device 7 and the respective container 2 can be obtained, so that such distance is maintained constant during the entire decoration process, even when the decoration is to be engraved along the entire axial length of the container 2.

Flexibility and adaptability of decoration machine 1 are thereby substantially improved without compromising the quality of the decoration and without the need for cumbersome adaptations and modifications.

Each support member 4 comprises a respective support plate 12 movably mounted to the carousel 3 for receiving and supporting a container.

Each support member 4 comprises a respective actuator 13 coupled to the plate 12 for driving a movement of the plate 12 in the axial direction, relatively to the carousel 3. The plates 12 are selectively axially movable by the relative actuators 13 during their advancement along said decoration path P, for adjusting an axial position of the containers 2 supported thereon.

This configuration allows for a further flexibility of the decoration process.

This configuration may also allow for a further decoration of the containers 2 at a different section of decoration path D. For example, decoration machine 1 may comprise a labelling module (not shown) configured to apply labels to containers 2 at a different axial height than the decorations engraved by laser engraving devices 7.

Hence, an even more flexible and multipurpose decoration machine 1 may be obtained.

The advantages of decoration machine 1 according to the present invention will be clear from the foregoing description.

In particular, the total number of the laser sources 6 can be reduced, since one single laser source 6 may be used to selectively feed a single laser beam L to a plurality of laser engraving devices 7, by means of the switching device 8.

Hence, the total number of components of decoration machine 1 can be reduced. This results in a simplified architecture, reduced costs, simplified maintenance operations and in an increase in the overall reliability of decoration machine 1.

Furthermore, the decoration process is more clean, reliable and entails a reduced consumption of raw materials, with respect to the standard decorations.

Clearly, changes may be made to decoration machine 1 as described herein without, however, departing from the scope of protection as defined in the accompanying claims.

In particular, in case each laser decoration unit 5 comprises three or more laser engraving devices 7, the switching device 8 may be configured for selectively directing the laser beam L towards at least two selected laser engraving devices 7a of the at least three laser engraving devices 7 at a time. Specifically, switching device 8 may direct laser beam L towards all the laser engraving devices 7 of the respective laser decoration unit 5 which are transiting through decoration angular sector a.

1. A decoration machine for decorating containers adapted to contain a pourable product, the machine comprising:
a rotary conveyor for conveying a plurality of containers along a decoration path;
a plurality of support members mounted on the conveyor for being advanced along the decoration path, each support member being configured to support in advancement a respective container;
the plurality of support members including at least one group of support members, said group comprising at least two respective support members;
wherein the machine comprises, for each group of support members, a respective laser decoration unit for engraving a decoration on the containers supported by the support members of the group;
wherein each laser decoration unit comprises:
respective a laser source configured to emit a laser beam;
at least two respective laser engraving devices, each configured to receive the laser beam and each associated to one respective support member of the group for engraving a container supported thereon by means of the received laser beam, each laser device being integral with the advancement of the associated support member; and
a respective switching device which is operatively interposed between the laser source and each laser engraving device of the decoration unit, the switching device being configured for selectively directing the laser beam towards each engraving device of the decoration unit.

2. The decoration machine as claimed in claim 1, comprising at least one control unit for controlling the switching device of each decoration unit, the at least one control unit being configured, for each decoration unit, for automatically selecting each engraving device of the decoration unit depending on a position of the associated support member along the decoration path, and for automatically controlling the switching device so that the laser beam is directed towards each selected laser engraving device of the unit.

3. The decoration machine as claimed in claim 1, wherein:
the rotary conveyor is configured to convey the containers along the decoration path by means of a rotary movement;
each support member is integral with said rotary movement; and
each laser decoration unit comprises a respective supporting structure which is mounted to the rotary conveyor, which is integral with said rotary movement and which supports each laser engraving device of the decoration unit so that each laser engraving device of the decoration unit is integral with said rotary movement.

4. The decoration machine as claimed in claim 3, wherein the rotary conveyor comprises a carousel rotatable about a central axis, so that the decoration path is arc-shaped and so that said rotary movement comprises a rotation about the central axis,
the support members are mounted on a radial peripheral portion of the carousel, with respect to the central axis, so as to be advanced by the carousel along a circular path including the decoration path.

5. The decoration machine as claimed in claim 4, wherein the machine is configured so that each container is engraved along a decoration angular sector (α), with respect to said axis (X);
and wherein, for each laser decoration unit, an at least one control unit is configured for selecting each laser engraving device for which the associated support member is within the decoration angular sector (α).

6. The decoration machine as claimed in claim 3, wherein, for each laser decoration unit, the supporting structure is configured to convey the laser beam from the respective laser source selectively to each laser engraving device of the decoration unit, in such a way that the laser beam is directed from the switching device to each selected laser engraving device through the supporting structure, the switching device being an optical switch defined by a system of mirrors arranged within structure.

7. The decoration machine as claimed in claim 3, wherein each laser engraving device is arranged in a position radially more external than the position of the associated support member, with respect to a central axis.

8. The decoration machine as claimed in claim 3, wherein each laser engraving device is mounted on the supporting structure so as to be movable in an axial direction, in a radial direction, or both with respect to a central axis, and relative to the associated support member.

9. The decoration machine as claimed in claim 3, wherein each support member comprises:
a support plate movably mounted to for receiving and supporting a container;
an actuator coupled to the plate for driving a movement of the plate in an axial direction, relatively to the carousel; and
wherein the plates are selectively axially movable by the relative actuators during their advancement along said decoration path, for adjusting an axial position of the containers supported thereon.

10. The decoration machine according to claim 3, wherein, for each decoration unit, the supporting structure supports also the laser source and the switching device, so that each of the laser source and the switching device is integral with the rotary movement.

11. The decoration machine according to claim 10, wherein the at least one control unit comprises, for each decoration unit, a respective control unit which is supported by the respective supporting structure.

12. The decoration machine according to claim 1, wherein the plurality of support members comprises a plurality of groups of support members.

13. The decoration machine as claimed in claim 1, wherein, for each laser decoration unit, the switching device comprises a respective optical switch for deviating the laser beam towards each selected laser engraving device.

14. The decoration machine according to claim 1, further comprising an aspirator device configured for sucking residual particles of the containers following the engraving thereof by means of the laser engraving devices.

15. A packaging assembly for packaging a pourable product by means of containers, the assembly comprising:
a filling machine for filling the containers with the pourable product;
a capping machine for capping the filled containers;
a decoration machine;
the filling machine, the capping machine and the decoration machine being synchronized with one another;
wherein the decorating machine comprises:
a rotary conveyor for conveying a plurality of containers along a decoration path;
a plurality of support members mounted on the conveyor for being advanced along the decoration path, each support member being configured to support in advancement a respective container;
the plurality of support members including at least one group of support members, said group comprising at least two respective support members;
wherein the machine comprises, for each group of support members, a respective laser decoration unit for engraving a decoration on the containers supported by the support members of the group;
wherein each laser decoration unit comprises:
a respective laser source configured to emit a laser beam;
at least two respective laser engraving devices, each configured to receive the laser beam and each associated to one respective support member of the group for engraving a container supported thereon by means of the received laser beam, each laser device being integral with the advancement of the associated support member; and
a respective switching device which is operatively interposed between the laser source and each laser engraving device of the decoration unit, the switching device being configured for selectively directing the laser beam towards each engraving device of the decoration unit.
